(19) United States
(12) Patent Application Publication
(10) Pub. No.: US 2025/0284770 A1
(43) Pub. Date: Sep. 11, 2025

(54) SIGN EXTENSION FOR IN-MEMORY COMPUTING

(71) Applicant: Rain Neuromorphics Inc., San Francisco, CA (US)

(72) Inventors: Burak Erbagci, San Jose, CA (US); Jack David Kendall, San Mateo, CA (US)

(21) Appl. No.: 19/033,300

(22) Filed: Jan. 21, 2025

Related U.S. Application Data
(60) Provisional application No. 63/624,109, filed on Jan. 23, 2024.

(51) Int. Cl. G06F 17/16

(52) U.S. Cl. CPC G06F 17/16

(57) ABSTRACT

A compute engine including a memory and compute logic is described. The memory includes storage cells. The compute logic is coupled with the memory and configured to perform a vector matrix multiplication (VMM) of an input vector with data stored in each storage cell. The input vector may include positive element(s) and negative element(s). The compute logic is configured to perform the VMM by: multiplying the positive element(s) with data stored in each storage cell of a first portion of storage cells corresponding to the positive element(s) to provide first product(s); accumulating, as a first output, the first product(s); multiplying the negative element(s) with data stored in each storage cell of a second portion of the storage cells corresponding to the negative element(s) to provide second product(s); accumulating, as a second output, the second product(s); and subtracting the second output from the first output to provide a VMM output.

### CROSS REFERENCE TO OTHER APPLICATIONS

This application claims priority to U.S. Provisional Patent Application No. 63/624,109 entitled SIGN EXTENSION OF IN-MEMORY COMPUTING filed Jan. 23, 2024 which is incorporated herein by reference for all purposes.

### BACKGROUND OF THE INVENTION

Artificial intelligence (AI), or machine learning, utilizes learning networks loosely inspired by the brain in order to solve problems. Learning networks typically include layers of weights that weight signals (mimicking synapses) combined with activation layers that apply functions to the signals (mimicking neurons). The weight layers are typically interleaved with the activation layers. In the forward, or inference, path, an input signal (e.g. an input vector) is propagated through the learning network. In so doing, a weight layer can be considered to multiply input signals (the input vector, or “activation”, for that weight layer) by the weights (or matrix of weights) stored therein and provide corresponding output signals. For example, the weights may be analog resistances or stored digital values that are multiplied by the input current, voltage or bit signals corresponding to the input vector. The weight layer provides weighted input signals to the next activation layer, if any. Neurons in the activation layer operate on the weighted input signals by applying some activation function (e.g. ReLU or Softmax) and provide output signals corresponding to the statuses of the neurons. The output signals from the activation layer are provided as input signals (i.e. the activation) to the next weight layer, if any. This process may be repeated for the layers of the network, providing output signals that are the resultant of the inference. Learning networks are thus able to reduce complex problems to a set of weights and the applied activation functions. The structure of the network (e.g. the number of and connectivity between layers, the dimensionality of the layers, the type of activation function applied), including the value of the weights, is known as the model.

Although a learning network is capable of solving challenging problems, the computations involved in using such a network are often time consuming. For example, a learning network may use millions of parameters (e.g. weights), which are multiplied by the activations to utilize the learning network. Learning networks can leverage hardware, such as graphics processing units (GPUs) and/or AI accelerators, which perform operations usable in machine learning in parallel. Such tools can improve the speed and efficiency with which data-heavy and other tasks can be accomplished by the learning network.

However, challenges still exist. For example, it may be desirable for the activations (i.e. input vectors) and/or the weights to include positive and negative values. Accounting for negative values for the input vectors may increase the components used in a hardware accelerator and complicate the connections between the components and increase power consumption. The use of positive and negative activations may be a particular challenge for edge devices or other devices for which space is at a premium and power consumption is desired to be managed. Consequently, improvements are still desired.

### BRIEF DESCRIPTION OF THE DRAWINGS

Various embodiments of the invention are disclosed in the following detailed description and the accompanying drawings.

FIGS. 1A-1B depict an embodiment of a portion of a compute engine usable in an accelerator for a learning network and a compute tile with which the compute engine may be used.

FIG. 2 depicts an embodiment of a portion of a compute engine usable in an accelerator for a learning network and capable of performing local updates.

FIG. 3 depicts an embodiment of a portion of a compute-in-memory module usable in an accelerator for a learning network.

FIGS. 4A-4B depicts an embodiment of a portion of a compute-in-memory module usable in an accelerator for a learning network.

FIG. 5 is a flow chart depicting an embodiment of a method for using a compute engine for performing operations using positive and negative values.

FIG. 6 depicts an embodiment of a portion of a compute engine usable in an accelerator for a learning network and for which input vectors may include positive and negative elements.

FIG. 7 depicts an embodiment of a portion of a compute engine usable in an accelerator for a learning network and which selectively masks elements of input vectors.

FIG. 8 is a flow chart depicting an embodiment of a method for using a compute engine for performing operations using positive and negative values.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Learning networks typically include layers of weights interleaved with activation layers. A weight layer may be considered to include a matrix where each of the elements is a weight. In a weight layer, an activation, or input vector, is multiplied by the weight matrix. Activation layers apply activation functions to the output of the preceding weight layer. Learning networks can use hardware, such as graphics processing units (GPUs) and/or hardware accelerators, to perform operations in parallel. For example, hardware accelerators may be used to perform functions such as vector-matrix multiplications (VMMs) for a weight layer. In a hardware accelerator, a weight matrix for a layer may be stored in a memory. One or more storage cells store data for each weight (i.e. each element of the weight matrix). The elements of the input vector may be multiplied by the values of the weights in corresponding storage cells and the products added as part of performing a VMM.

For some applications, it may be desirable for elements of the input vector to be capable of being positive or negative. Accounting for negative values for the input vectors may be challenging. For example, for input vectors represented in binary form, a sign bit might be added as the most significant bit to indicate a positive value (e.g. the sign bit is a logical zero) or a negative value (e.g. the sign bit is a logical one). The hardware carrying out the multiplication including dedicated hardware or individually accounting for the sign bits of the input vector in each multiplication. Based its sign, the product of a weight and an element of the input vector is added or subtracted as part of the VMM. However, this may significantly complicate the hardware and increase power consumption. Consequently, use of positive and negative activations and/or weights may be difficult. For edge devices, for which power and space are limited, this may be particularly challenging. Consequently, improvements are still desired.

A compute engine including a memory and compute logic is described. The memory includes a plurality of storage cells. The compute logic is coupled with the memory and configured to perform a vector matrix multiplication (VMM) of an input vector with data stored in each of the storage cells. The input vector may include positive element(s) and negative element(s). The memory and at least a portion of the compute logic are part of a compute-in-memory (CIM) hardware module. The compute logic is configured to perform the VMM by: multiplying the positive element(s) with data stored in each storage cell of a first portion of the storage cells corresponding to the positive element(s) to provide first product(s); accumulating, as a first output, the first product(s) for each storage cell of the first portion of the storage cells; multiplying the negative element(s) with data stored in each storage cell of a second portion of the storage cells corresponding to the negative element(s) to provide second product(s); accumulating, as a second output, the second product(s) for each storage cell of the second portion of the storage cells; and subtracting the second output from the first output to provide a VMM output.

The memory and at least a portion of the compute logic may be part of a compute-in-memory (CIM) hardware module. The compute engine may be configured to present only the positive element(s) to the CIM hardware module to provide the first product(s). The compute engine may also be configured to present only the negative element(s) to the CIM hardware module to provide the second product(s).

In some embodiments, the memory and at least a portion of the compute logic are part of a CIM hardware module. In such embodiments, the compute engine may further include an input buffer coupled with the CIM hardware module. The input buffer may be configured to separately provide the positive element(s) to the CIM hardware module and provide the negative element(s) to the CIM hardware module. In some embodiments, the input buffer is configured to present only the positive element(s) to the CIM hardware module to provide the first product(s) and to present only the negative element(s) to the CIM hardware module to provide the second product(s). In some such embodiments, the input buffer includes control logic configured to mask the negative element(s) for the first product(s) and to mask the positive element(s) for the second product(s). The input buffer may also be configured to serialize the at least one negative element and the at least one positive element.

In some embodiments, the compute logic further includes logic gate(s) coupled to each of the storage cells. The logic gate(s) are configured to perform a multiplication of a portion of the input vector and the data in each of the storage cells. In some embodiments, each of the storage cells is programmable by a voltage not exceeding 0.6 Volts.

A compute tile is described. The compute tile includes at least one general-purpose (GP) processor and a plurality of compute engines coupled with the GP processor(s). Each compute engine includes a compute-in-memory (CIM) hardware module including memory and compute logic coupled with the memory. The memory includes storage cells. The compute logic is configured to perform a vector matrix multiplication (VMM) of an input vector with data stored in each of the storage cells. The input vector may include positive element(s) and negative element(s). Each of the compute engines is configured to perform the VMM by: multiplying, using the compute logic, the positive element(s) with data stored in each storage cell of a first portion of the storage cells corresponding to the positive element(s) to provide first product; accumulating, using the compute logic, as a first output the first product for each storage cell of the first portion of the; multiplying, using the compute logic, the negative element(s) with data stored in each storage cell of a second portion of the storage cells corresponding to the negative element(s) to provide second product(s); accumulating, using the compute logic, as a second output the second product(s) for each storage cell of the second portion of the storage cells, and subtracting, using the compute logic, the second product from the first product to provide a VMM output.

In some embodiments, the compute engine is configured to present only the positive element(s) to the CIM hardware module to provide the first product and to present only the negative element(s) to the CIM hardware module to provide the second product. In some embodiments, each compute engine further includes an input buffer coupled with the CIM hardware module. The input buffer is configured to separately provide the positive element(s) to the CIM hardware module and provide the negative element(s) to the CIM hardware module. The input buffer may be configured to present only the positive element(s) to the CIM hardware module to provide the first product(s) and to present only the negative element(s) to the CIM hardware module to provide the second product(s). The input buffer may include control logic configured to mask the negative element(s) for the first product(s) and to mask the positive element(s) for the second product(s). In some such embodiments, the input buffer is further configured to serialize the negative element(s) and the positive element(s). The compute logic may include logic gate(s) coupled to each of the storage cells. The logic gate(s) are configured to perform a multiplication of a portion of the input vector and the data in each of the storage cells. In some embodiments, each of the storage cells is programmable by a voltage not exceeding 0.6 Volts.

A method is described. The method includes performing, by a compute engine, a vector-matrix multiplication (VMM) of an input vector and a matrix. The matrix includes data stored in each of a plurality of storage cells of a memory of the compute engine. The memory is coupled with the compute logic. The input vector may include positive element(s) and negative element(s). Performing the VMM further includes: multiplying the positive element(s) with data stored in each storage cell of a first portion of the storage cells corresponding to the positive element(s) to provide first product(s); accumulating as a first output the first product(s); multiplying the negative element(s) with data stored in each storage cell of a second portion of the plurality of storage cells corresponding to the negative element(s) to provide second product(s); accumulating as a second output the second product(s); and subtracting the second product from the first product to provide a VMM output.

In some embodiments, multiplying the positive element(s) with the data further includes presenting only the positive element(s) to a CIM hardware module to provide the at least one first product. The CIM hardware module includes the memory and the compute logic. In such embodiments, multiplying the negative element(s) with the data further includes presenting only the negative element(s) to the CIM hardware module to provide the second product. Presenting only the positive element(s) may further include masking the negative element(s) for the first product(s). Similarly, presenting only the negative element(s) may include masking the positive element(s) for the second product(s). In some embodiments, presenting only the positive element(s) includes serializing the positive element(s). Presenting only the negative element(s) may include serializing the negative element(s).

The methods and systems are described in the context of particular features. For example, certain embodiments may highlight particular features. However, the features described herein may be combined in manners not explicitly described. Although described in the context of particular compute engines, CIM hardware modules, storage cells, and logic, other components may be used. For example, although particular embodiments utilize digital SRAM storage cells, other storage cells, including but not limited to analog storage cells (e.g. resistive storage cells) may be used. Similarly, although described in the context of weights and activations, other input vectors (or matrices) and other tensors may be used in conjunction with the methods and systems described herein.

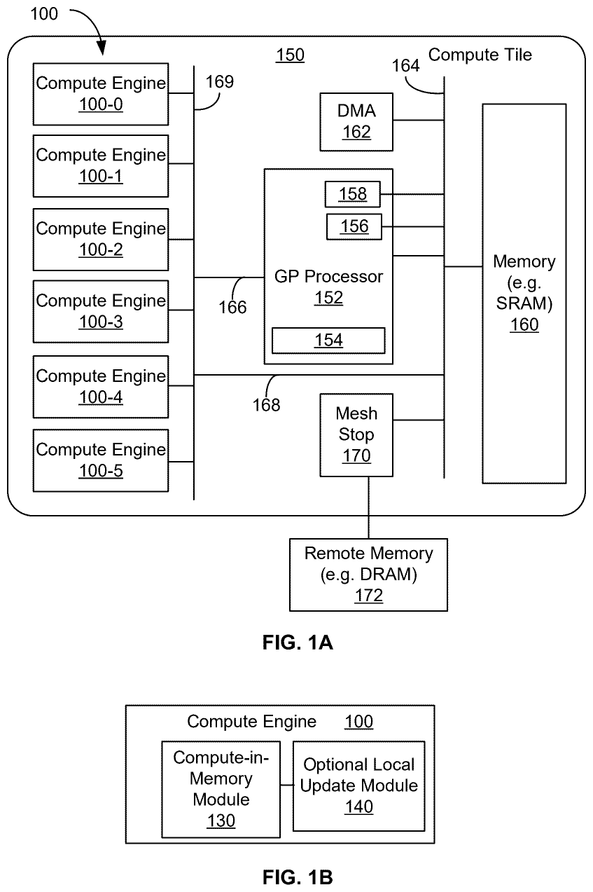

FIGS. 1A-1B depict an embodiment of a portion of compute engine 100 usable in an accelerator for a learning network and compute tile 150 (i.e. an embodiment of the environment) in which the compute engine may be used. FIG. 1A depicts compute tile 150 in which compute engine 100 may be used. FIG. 1B depicts compute engine 100. Compute engine 100 may be part of an AI accelerator that can be deployed for using a model (not explicitly depicted) and, in some embodiments, for allowing for on-chip training of the model (otherwise known as on-chip learning). Referring to FIG. 1A, system 150 is a compute tile and may be considered to be an artificial intelligence (AI) accelerator having an efficient architecture. Compute tile (or simply “tile”) 150 may be implemented as a single integrated circuit. Compute tile 150 includes a general purpose (GP) processor 110 and compute engines 100-0 through 100-5 (collectively or generically compute engines 100) which are analogous to compute engine 100 depicted in FIG. 1A. Also shown are on-tile memory 160 (which may be an SRAM memory) direct memory access (DMA) unit 162, and mesh stop 170. Thus, compute tile 150 may access remote memory 172, which may be DRAM. Remote memory 172 may be used for long term storage. In some embodiments, compute tile 150 may have another configuration. Further, additional or other components may be included on compute tile 150 or some components shown may be omitted. For example, although six compute engines 100 are shown, in other embodiments another number may be included. Similarly, although on-tile memory 160 is shown, in other embodiments, memory 160 may be omitted. GP processor 152 is shown as being coupled with compute engines 100 via compute bus (or other connector) 169 and bus 166. Compute engines 100 are also coupled to bus 164 via bus 168. In other embodiments, GP processor 152 may be connected with compute engines 100 in another manner.

In some embodiments, GP processor 152 is a reduced instruction set computer (RISC) processor. For example, GP processor 152 may be a RISC-V processor or ARM processor. In other embodiments, different and/or additional general purpose processor(s) may be used. The GP processor 152 provides control instructions and, in some embodiments, data to the compute engines 100. GP processor 152 may thus function as part of a control plane for (i.e. providing commands) and is part of the data path for compute engines 100 and tile 150. GP processor 152 may also perform other functions. GP processor 152 may apply activation function(s) to data. For example, an activation function (e.g. a ReLu, Tan h, and/or SoftMax) may be applied to the output of compute engine(s) 100. Thus, GP processor 152 may perform nonlinear operations. GP processor 152 may also perform linear functions and/or other operations. However, GP processor 152 is still desired to have reduced functionality as compared to, for example, a graphics processing unit (GPU) or central processing unit (CPU) of a computer system with which tile 150 might be used.

In some embodiments, GP processor includes an additional fixed function compute block (FFCB) 154 and local memories 156 and 158. In some embodiments, FFCB 154 may be a single instruction multiple data arithmetic logic unit (SIMD ALU). In some embodiments, FFCB 154 may be configured in another manner. FFCB 154 may be a close-coupled fixed-function unit for on-device inference and training of learning networks. In some embodiments, FFCB 154 executes nonlinear operations, number format conversion and/or dynamic scaling. In some embodiments, other and/or additional operations may be performed by FFCB 154. FFCB 154 may be coupled with the data path for the vector processing unit of GP processor 1310. In some embodiments, local memory 156 stores instructions while local memory 158 stores data. GP processor 152 may include other components, such as vector registers, that are not shown for simplicity.

Memory 160 may be or include a static random access memory (SRAM) and/or some other type of memory. Memory 160 may store activations (e.g. input vectors provided to compute tile 150 and the resultant of activation functions applied to the output of compute engines 100). Memory 160 may also store weights. For example, memory 160 may contain a backup copy of the weights or different weights if the weights stored in compute engines 100 are desired to be changed. In some embodiments, memory 160 is organized into banks of cells (e.g. banks of SRAM cells). In such embodiments, specific banks of memory 160 may service specific one(s) of compute engines 100. In other embodiments, banks of memory 160 may service any compute engine 100.

Mesh stop 172 provides an interface between compute tile 150 and the fabric of a mesh network that includes compute tile 150. Thus, mesh stop 172 may be used to communicate with remote DRAM 190. Mesh stop 172 may also be used to communicate with other compute tiles (not shown) with which compute tile 150 may be used. For example, a network on a chip may include multiple compute tiles 150, a GPU or other management processor, and/or other systems which are desired to operate together.

Compute engines 100 are configured to perform, efficiently and in parallel, tasks that may be part of using (e.g. performing inferences) and/or training (e.g. performing inferences and/or updating weights) a model. Compute engines 100 are coupled with and receive commands and, in at least some embodiments, data from GP processor 152. Compute engines 100 are modules which perform vector-matrix multiplications (VMMs) in parallel. Thus, compute engines 100 may perform linear operations. Each compute engine 100 includes a compute-in-memory (CIM) hardware module (shown in FIG. 1A). The CIM hardware module stores weights corresponding to a matrix and is configured to perform a VMM in parallel for the matrix. Compute engines 100 may also include local update (LU) module(s) (shown in FIG. 1A). Such LU module(s) allow compute engines 100 to update weights stored in the CIM. In some embodiments, such LU module(s) may be omitted.

Referring to FIG. 1B, compute engine 100 includes CIM hardware module 130 and optional LU module 140. Although one CIM hardware module 130 and one LU module 140 is shown, a compute engine may include another number of CIM hardware modules 130 and/or another number of LU modules 140. For example, a compute engine might include three CIM hardware modules 130 and one LU module 140, one CIM hardware module 130 and two LU modules 140, or two CIM hardware modules 130 and two LU modules 140.

CIM hardware module 130 is a hardware module that stores data and performs operations. In some embodiments, CIM hardware module 130 stores weights for the model. CIM hardware module 130 also performs operations using the weights. More specifically, CIM hardware module 130 performs vector-matrix multiplications, where the vector may be an input vector provided and the matrix may be weights (i.e. data/parameters) stored by CIM hardware module 130. Thus, CIM hardware module 130 may be considered to include a memory (e.g. that stores the weights) and compute hardware, or compute logic, (e.g. that performs in parallel the vector-matrix multiplication of the stored weights). In some embodiments, the vector may be a matrix (i.e. an n×m vector where n>1 and m>1). For example, CIM hardware module 130 may include an analog static random access memory (SRAM) having multiple SRAM cells and configured to provide output(s) (e.g. voltage(s)) corresponding to the data (weight/parameter) stored in each cell of the SRAM multiplied by a corresponding element of the input vector. In some embodiments CIM hardware module 130 may include a digital static SRAM having multiple SRAM cells and configured to provide output(s) corresponding to the data (weight/parameter) stored in each cell of the digital SRAM multiplied by a corresponding element of the input vector, hardware voltage(s) corresponding to the impedance of each cell multiplied by the corresponding element of the input vector. Other configurations of CIM hardware module 230 are possible. Each CIM hardware module 130 thus stores weights corresponding to a matrix in its cells and is configured to perform a vector-matrix multiplication of the matrix with an input vector.

In order to facilitate on-chip learning, LU module 140 may be provided. LU module 140 is coupled with the corresponding CIM hardware module 130. LU module 140 is used to update the weights (or other data) stored in CIM hardware module 130. LU module 140 is considered local because LU module 140 is in proximity with CIM module 130. For example, LU module 140 may reside on the same integrated circuit as CIM hardware module 130. In some embodiments LU module 140 for a particular compute engine resides in the same integrated circuit as the CIM hardware module 130. In some embodiments, LU module 140 is considered local because it is fabricated on the same substrate (e.g. the same silicon wafer) as the corresponding CIM hardware module 130. In some embodiments, LU module 140 is also used in determining the weight updates. In other embodiments, a separate component may calculate the weight updates. For example, in addition to or in lieu of LU module 140, the weight updates may be determined by a GP processor, in software by other processor(s) not part of compute engine 100 and/or the corresponding AI accelerator, by other hardware that is part of compute engine 100 and/or the corresponding AI accelerator, by other hardware outside of compute engine 100 or the corresponding AI accelerator.

Using compute engine 100 efficiency and performance of a learning network may be improved. Use of CIM hardware modules 130 may dramatically reduce the time to perform the vector-matrix multiplication that provides the weighted signal. Thus, performing inference(s) using compute engine 100 may require less time and power. This may improve efficiency of training and use of the model. LU modules 140 allow for local updates to the weights in CIM hardware modules 130. This may reduce the data movement that may otherwise be required for weight updates. Consequently, the time taken for training may be greatly reduced. In some embodiments, the time taken for a weight update using LU modules 140 may be an order of magnitude less (i.e. require one-tenth the time) than if updates are not performed locally. Efficiency and performance of a learning network provided using system 100 may be increased.

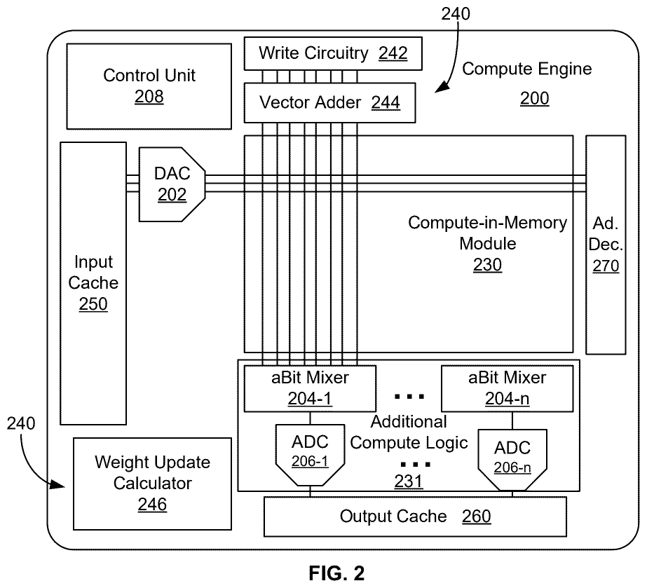

FIG. 2 depicts an embodiment of compute engine 200 usable in an AI accelerator and that may be capable of performing local updates. Compute engine 200 may be a hardware compute engine analogous to compute engine 100. Compute engine 200 thus includes CIM hardware module 230 and optional LU module 240 analogous to CIM hardware modules 130 and LU modules 140, respectively. Compute engine 200 includes input cache 250, output cache 260, and address decoder 270. Additional compute logic 231 is also shown. In some embodiments, additional compute logic 231 includes analog bit mixer (aBit mixer) 204-1 through 204-n (generically or collectively 204), and analog to digital converter(s) (ADC(s)) 206-1 through 206-n (generically or collectively 206). However, for a fully digital CIM hardware module 230, additional compute logic 231 may include logic such as adder trees and accumulators. In some embodiments, such logic may simply be included as part of CIM hardware module 230. In some embodiments, therefore, the output of CIM hardware module 230 may be provided to output cache 260. Although particular numbers of components 202, 204, 206, 230, 231, 240, 242, 244, 246, 260, and 270 are shown, another number of one or more components 202, 204, 206, 230, 231, 240, 242, 244, 246, 160, and 270 may be present. Further, in some embodiments, particular components may be omitted or replaced. For example, DAC 202, analog bit mixer 204, and ADC 206 may be present only for analog weights.

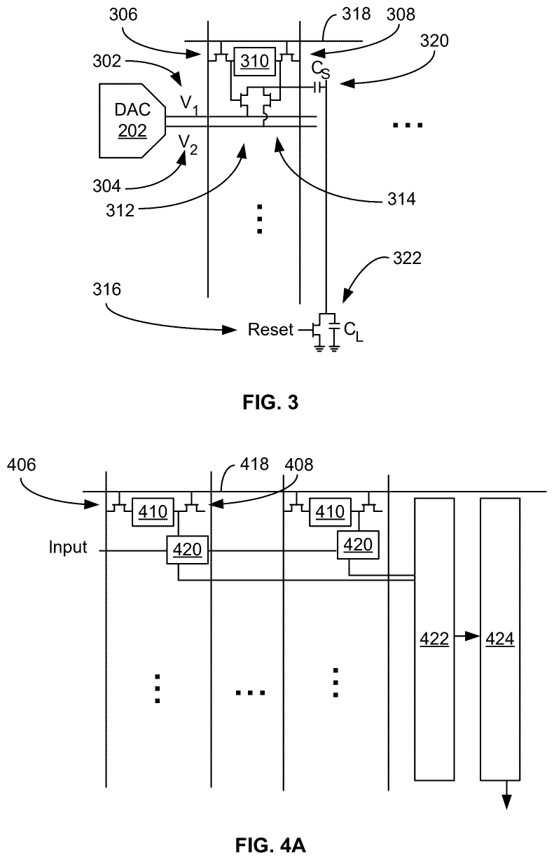

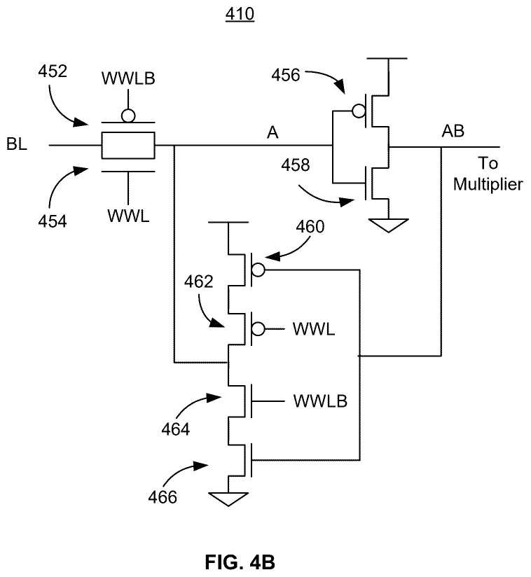

CIM hardware module 230 is a hardware module that stores data corresponding to weights and performs vector-matrix multiplications. The vector is an input vector provided to CIM hardware module 230 (e.g. via input cache 250) and the matrix includes the weights stored by CIM hardware module 230. In some embodiments, the vector may be a matrix. Examples of embodiments CIM modules that may be used in CIM hardware module 230 are depicted in FIGS. 3 and 4.

FIG. 3 depicts an embodiment of a cell in one embodiment of an SRAM CIM module usable for CIM hardware module 230. Also shown is DAC 202 of compute engine 200. For clarity, only one SRAM cell 310 is shown. However, multiple SRAM cells 310 may be present. For example, multiple SRAM cells 310 may be arranged in a rectangular array. An SRAM cell 310 may store a weight or a part of the weight. The CIM hardware module shown includes lines 302, 304, and 318, transistors 306, 308, 312, 314, and 316, capacitors 320 (C_{S}) and 322 (C_{L}). In the embodiment shown in FIG. 3, DAC 202 converts a digital input voltage to differential voltages, V₁ and V₂, with zero reference. These voltages are coupled to each cell within the row. DAC 202 is thus used to temporal code differentially. Lines 302 and 304 carry voltages V₁ and V₂, respectively, from DAC 202. Line 318 is coupled with address decoder 270 (not shown in FIG. 3) and used to select cell 310 (and, in the embodiment shown, the entire row including cell 310), via transistors 306 and 308.

In operation, voltages of capacitors 320 and 322 are set to zero, for example via Reset provided to transistor 316. DAC 202 provides the differential voltages on lines 302 and 304, and the address decoder (not shown in FIG. 3) selects the row of cell 310 via line 318. Transistor 312 passes input voltage V₁ if SRAM cell 310 stores a logical 1, while transistor 314 passes input voltage V₂ if SRAM cell 310 stores a zero. Consequently, capacitor 320 is provided with the appropriate voltage based on the contents of SRAM cell 310. Capacitor 320 is in series with capacitor 322. Thus, capacitors 320 and 322 act as capacitive voltage divider. Each row in the column of SRAM cell 310 contributes to the total voltage corresponding to the voltage passed, the capacitance, C_{S}, of capacitor 320, and the capacitance, C_{L}, of capacitor 322. Each row contributes a corresponding voltage to the capacitor 322. The output voltage is measured across capacitor 322. In some embodiments, this voltage is passed to the corresponding aBit mixer 204 for the column. In some embodiments, capacitors 320 and 322 may be replaced by transistors to act as resistors, creating a resistive voltage divider instead of the capacitive voltage divider. Thus, using the configuration depicted in FIG. 3, CIM hardware module 230 may perform a vector-matrix multiplication using data stored in SRAM cells 310.

FIGS. 4A-4B depicts an embodiment of a cell in one embodiment of a digital SRAM module usable for CIM hardware module 230. FIG. 4A depicts digital SRAM cells 410 in a CIM hardware module. FIG. 4B depicts the underlying circuitry in one embodiment of digital SRAM cell 410. For clarity, only one digital SRAM cell 410 is labeled. However, multiple cells 410 are present and may be arranged in a rectangular array. Also labeled are corresponding transistors 406 and 408 for each cell, line 418, logic gates 420, adder tree 422 and accumulator 424.

Storage cell 410 may be constructed in various ways. For example, some typical storage cells may include six transistors. However, such storage cells 410 may be configured such that the array of storage cells 410 and logic gates 420 used for multiplication occupy more area than desired. Further, such storage cells may require higher voltages than desired to be written. This is particularly true in applications for which power is desired to be conserved, for example when used in edge devices. FIG. 4B depicts an embodiment of storage cells 410 that includes eight transistors 452, 454, 456, 458, 460, 462, 464, and 466. In some embodiments, storage cell 410 may be written at voltages not exceeding 0.7 V. In some embodiments, the write voltage for storage cell 410 does not exceed 0.6 V. In some embodiments, the write voltage for storage cell 410 does not exceed 0.5 V. Thus, storage cell 410 may be written using a lower voltage and may draw less power. Eight transistor storage cell 410 in combination with logic gate(s) 420 may consume less area than another storage cell, such as a traditional six transistor storage cell, in combination with storage gates 420. Thus, area may also be conserved. As a result, storage cell 410 may be of particular applications for which low power usage and/or reduced area is desired. For example, storage cell 410 may be particularly desirable in edge devices.

In operation, a row including digital SRAM cell 410 is enabled by address decoder 270 (not shown in FIG. 4) using line 418. Transistors 406 and 408 are enabled, allowing the data stored in digital SRAM cell 410 to be provided to logic gates 420. Logic gates 420 combine the data stored in digital SRAM cell 410 with the input vector. Thus, the binary weights stored in digital SRAM cells 410 are combined with (e.g. multiplied by) the binary inputs. Thus, the multiplication performed may be a bit serial multiplication. The output of logic gates 420 are added using adder tree 422 and combined by accumulator 424. Thus, using the configuration depicted in FIG. 4, CIM hardware module 230 may perform a vector-matrix multiplication using data stored in digital SRAM cells 410.

Referring back to FIG. 2, CIM hardware module 230 thus stores weights corresponding to a matrix in its cells and is configured to perform a vector-matrix multiplication of the matrix with an input vector. In some embodiments, compute engine 200 stores positive weights in CIM hardware module 230. However, the use of both positive and negative weights may be desired for some models and/or some applications. In such cases, the sign may be accounted for by a sign bit or other mapping of the sign to CIM hardware module 230.

Input cache 250 receives an input vector for which a vector-matrix multiplication is desired to be performed. The input vector may be read from a memory, from a cache or register in the processor, or obtained in another manner. For analog cells, such as depicted in FIG. 3, digital-to-analog converter (DAC) 202 may convert a digital input vector to analog in order for CIM hardware module 230 to operate on the vector. Although shown as connected to only some portions of CIM hardware module 230, DAC 202 may be connected to all of the cells of CIM hardware module 230. Alternatively, multiple DACS 202 may be used to connect to all cells of CIM hardware module 230. Address decoder 270 includes address circuitry configured to selectively couple vector adder 244 and write circuitry 242 with each cell of CIM hardware module 230. Address decoder 270 selects the cells in CIM hardware module 230. For example, address decoder 270 may select individual cells, rows, or columns to be updated, undergo a vector-matrix multiplication, or output the results. In some embodiments, aBit mixer 204 combines the results from CIM hardware module 230. Use of aBit mixer 204 may save on ADCS 206 and allows access to analog output voltages. ADC(s) 206 convert the analog resultant of the vector-matrix multiplication to digital form. Output cache 260 receives the result of the vector-matrix multiplication and outputs the result from compute engine 200. Thus, a vector-matrix multiplication may be performed using CIM hardware module 230 and cells 310.

For a digital SRAM CIM module, input cache 250 may serialize an input vector. The input vector is provided to CIM hardware module 230. As previously indicated, DAC 202 may be omitted for a digital CIM hardware module 230, for example which uses digital SRAM storage cells 410. Logic gates 420 combine (e.g., multiply) the bits from the input vector with the bits stored in SRAM cells 410. The output is provided to adder trees 422 and to accumulator 424. In some embodiments, therefore, adder trees 422 and accumulator 424 may be considered to be part of CIM hardware module 230. The resultant is provided to output cache 260. Thus, a digital vector-matrix multiplication may be performed in parallel using CIM hardware module 230.

LU module 240 includes write circuitry 242 and vector adder 244. In some embodiments, LU module 240 includes weight update calculator 246. In other embodiments, weight update calculator 246 may be a separate component and/or may not reside within compute engine 200. Weigh update calculator 246 is used to determine how to update to the weights stored in CIM hardware module 230. In some embodiments, the updates are determined sequentially based upon target outputs for the learning system of which compute engine 200 is a part. In some embodiments, the weight update provided may be sign-based (e.g. increments for a positive sign in the gradient of the loss function and decrements for a negative sign in the gradient of the loss function). In some embodiments, the weight update may be ternary (e.g. increments for a positive sign in the gradient of the loss function, decrements for a negative sign in the gradient of the loss function, and leaves the weight unchanged for a zero gradient of the loss function). Other types of weight updates may be possible. In some embodiments, weight update calculator 246 provides an update signal indicating how each weight is to be updated. The weight stored in a cell of CIM hardware module 230 is sensed and is increased, decreased, or left unchanged based on the update signal. In particular, the weight update may be provided to vector adder 244, which also reads the weight of a cell in CIM hardware module 230. More specifically, adder 244 is configured to be selectively coupled with each cell of CIM hardware module by address decoder 270. Vector adder 244 receives a weight update and adds the weight update with a weight for each cell. Thus, the sum of the weight update and the weight is determined. The resulting sum (i.e. the updated weight) is provided to write circuitry 242. Write circuitry 242 is coupled with vector adder 244 and the cells of CIM hardware module 230. Write circuitry 242 writes the sum of the weight and the weight update to each cell. In some embodiments, LU module 240 further includes a local batched weight update calculator (not shown in FIG. 2) coupled with vector adder 244. Such a batched weight update calculator is configured to determine the weight update.

Compute engine 200 may also include control unit 208. Control unit 208 generates the control signals depending on the operation mode of compute engine 200. Control unit 240 is configured to provide control signals to CIM hardware module 230 and LU module 1549. Some of the control signals correspond to an inference mode. Some of the control signals correspond to a training, or weight update mode. In some embodiments, the mode is controlled by a control processor (not shown in FIG. 2, but analogous to processor 110) that generates control signals based on the Instruction Set Architecture (ISA).

Using compute engine 200, efficiency and performance of a learning network may be improved. CIM hardware module 230 may dramatically reduce the time to perform the vector-matrix multiplication. Thus, performing inference(s) using compute engine 200 may require less time and power. This may improve efficiency of training and use of the model. LU module 240 may perform local updates to the weights stored in the cells of CIM hardware module 230. This may reduce the data movement that may otherwise be required for weight updates. Consequently, the time taken for training may be dramatically reduced. Efficiency and performance of a learning network provided using compute engine 200 may be increased.

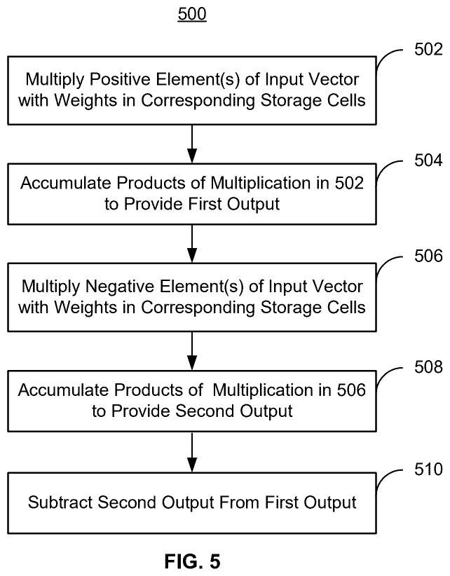

FIG. 5 is a flow chart depicting an embodiment of method 500 for using a compute engine for performing operations using positive and negative values. More specifically, method 500 may be used for performing VMMs for input vectors having elements which may be positive or negative. Method 500 is described in the context of compute engine 200. For example, a matrix of weights may be stored in storage cells (e.g. storage cells 410) of CIM module 230. Thus, method 500 is described in the context of a digital CIM module 230 and a compute engine 200, which omits DAC(s) 202, aBit mixers 204, and ADC(s) 206. However, method 500 is usable with other compute engines and CIM hardware modules, such as compute engine 100, compute tile 150, analog CIM hardware modules, other compute engine(s), and/or compute tile(s). Although particular processes are shown in an order, the processes may be performed in another order, including in parallel. Further, processes may have substeps.

Positive elements of the input vector are multiplied by the corresponding weights stored in storage cells, at 502. 502 may thus include a technique for distinguishing positive elements of the input vector from negative elements of the input vector. In some embodiment, this is accomplished using a sign bit for the elements of the input vector. Because 502 only multiplies the positive elements of the input vector by the corresponding weights, the resultants may be considered to be all positive (i.e. where the weights are all positive) or have a sign based on the sign of the weights (i.e. where the weights may be positive or negative). Stated differently, the product of an elements of the input vector and a corresponding weight has the sign of the weight. For simplicity, method 500 is described in the context of weights being positive. In some embodiments, method 500 may be extended to include positive and negative weights. In such embodiments, the sign of the weights is accounted for in the accumulation of 504 and 508. In some embodiments, 502 includes performing a bit serial multiplication for each element of the vector and each weight.

The products of the multiplication performed in 502 are accumulated, at 504. Stated differently, the products of 502 are added and stored. In some embodiments, 504 may be considered to be implemented by an adder tree and accumulator. Thus, at 504, the vector matrix multiplication of the positive elements of the input vector with corresponding elements of the weight matrix is stored as a first output.

Negative elements of the input vector are multiplied by the corresponding weights stored in storage cells, at 506. 506 may thus include a technique for distinguishing positive elements of the input vector from negative elements of the input vector. In some embodiment, this is accomplished using a sign bit for the elements of the input vector. Because 506 only multiplies the negative elements of the input vector by the corresponding weights, the resultants may be considered to be have the opposite sign of the weights (e.g. negative, where the weights are all positive).

The products of the multiplication performed in 506 are accumulated, at 508. Thus, the products of 506 are added and stored at 508. In some embodiments, 508 may be considered to be implemented by an adder tree and accumulator. Thus, at 508, the vector matrix multiplication of the negative elements of the input vector with corresponding elements of the weight matrix is stored as a second output. Because the positive and negative elements of the input vector are separated into different multiplication processes at 502 and 504 (positive) and 506 and 508 (negative), the same hardware may be used to perform 502, 504, 506, and 508 without separately accounting for the signs of the elements of the input vector. At 510, the second output (negative input vector elements) is subtracted from the first output (positive input vector elements). Thus, the resultant of the VMM has been determined.

For example, at 502 the positive elements of the input vector are provided from input buffer 250 (also termed input cache) to CIM hardware module 230. The negative elements of the input vector stored in input buffer 250 are not provided to CIM hardware module 230. In some embodiments, this may include forwarding zeroes to CIM hardware module 230 in place of the negative elements. CIM hardware module 230 performs the VMM for the positive elements of the input vector. For example, logic gates 420 multiply each bit of each positive element with the corresponding bit of the weight stored in storage cell 410 at 502. At 504, these products are appropriately added (e.g. via adder tree(s)) and stored (e.g. in accumulator(s)). In some embodiments, 504 may include accounting for negative weights in the adder tree(s) and/or accumulator(s). At 504, the first output of the VMM for the positive elements of the input vector may be stored separately, for example in a cache.

Similarly, at 506 the negative elements of the input vector are provided from input buffer 250 to CIM hardware module 230. The positive elements of the input vector stored in input buffer 250 are not provided to CIM hardware module 230. In some embodiments, this may include forwarding zeroes to CIM hardware module 230 in place of the positive elements. CIM hardware module 230 performs the VMM for the negative elements of the input vector. For example, logic gates 420 multiply each bit of each negative element with the corresponding bit of the weight stored in storage cell 410 at 506. At 508, these products are appropriately added (e.g. via adder tree(s)) and stored (e.g. in accumulator(s)). In some embodiments, 508 may include accounting for negative weights in the adder tree(s) and/or accumulator(s). Thus, the second output of the VMM for negative elements of the input vector has been determined. At 510, the second output is subtracted from the first output. Thus, the VMM has been performed.

Using method 500, a VMM may be performed for input vectors having elements with positive and/or negative values. Further, the hardware in CIM hardware module 230 may not be significantly changed in order to accommodate input vectors capable of having negative elements. Instead, the positive and negative elements are separately treated using existing adder trees, accumulators, and/or other hardware. Extra storage for storing the first output during determination of the second output may simply be added (or other existing storage used). Although method 500 is described in the context of performing VMMs for the positive elements of the input vector first, nothing prevents performing VMMs for the negative elements of the input vector from being performed first. Although method 500 may increase the time taken to perform the VMM, additional circuitry may be avoided. Thus, method 500 may extend compute engines, such as compute engine 100 and/or compute tile 150, to be usable with input vectors that include negative elements. Further, method 500 may reduce the peak power used in performing the VMM. Consequently, method 500 may have particular utility for edge devices.

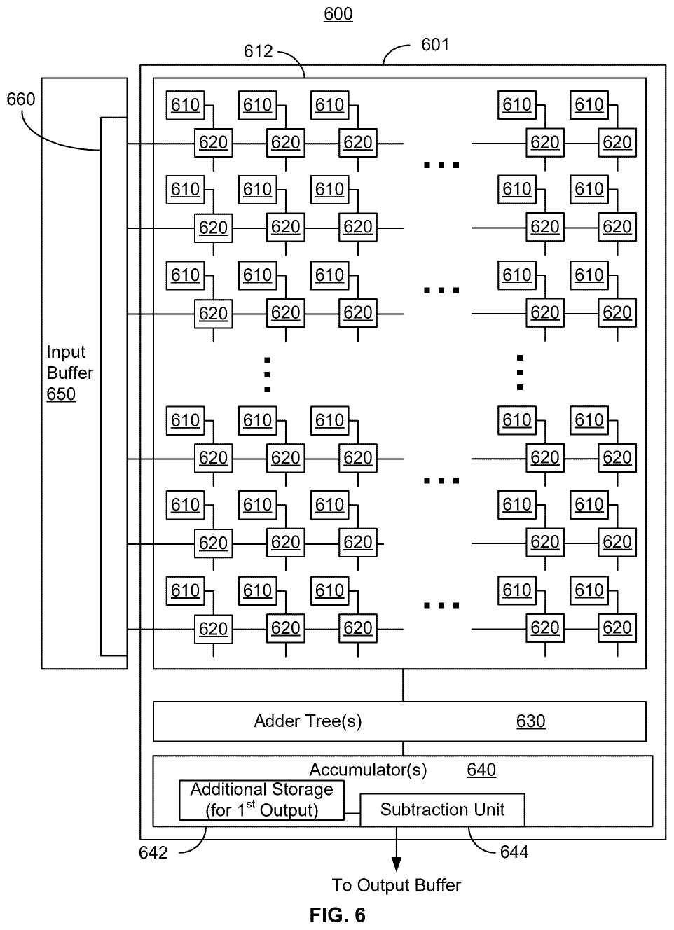

FIG. 6 depicts an embodiment of a portion of compute engine 600 usable in an accelerator for a learning network and for which input vectors may include positive and negative elements. Compute engine 600 is analogous to compute engines 100 and 200. Compute engine 600 includes CIM hardware module 601, input buffer 650, and an output buffer (not shown) that are analogous to CIM hardware modules 130 and 230, input buffer 250, and output buffer 260. For clarity, other components which may be present, such as address decoder 270, are not shown. CIM hardware module 601 includes storage cells 610 and compute logic. Storage cells 610 are analogous to storage cells 410 may be considered to be organized into array 612. Compute logic includes logic gates 620, adder tree(s) 630, and accumulator 640. Logic gates 620 are coupled with storage cells 610 and perform a bit wise multiplication of the data in the corresponding storage cell 610 and the input vector. For example, each logic gate(s) 620 may include a NOR gate that receives the inverted output of the data in corresponding storage cell 510 and the inverted bit of the input vector. Thus, the output of such a NOR gate is a 1 when the inputs are both 0 (i.e. both the storage cell 610 and the input vector bits each a 1). Logic gates 620 may be considered part of array 612. Although shown separately from array 612 and connected via a single line, adder tree(s) 630 and accumulator 640 are connected with logic gates 620 in array 612 to perform a VMM. Although described in the context of digital CIM module, nothing prevents the use of analog modules, for example storage of weights in resistive cells or other analogous storage cells.

Input buffer 650 is analogous to input buffer 250. However, input buffer 650 includes control logic 660 used to detect the sign of elements of the input vector. Similarly, adder tree(s) 630 and accumulator(s) 640 may be analogous to those used in CIM hardware module 203. In addition, additional storage 642 and an additional subtraction unit 644 have been provided.

Compute engine 600 may be used in conjunction with method 500. At 502 control logic 660 is used by input buffer 650 to provide positive elements of the input vector to array 612 of CIM hardware module 601. The negative elements of the input vector stored in input buffer 650 are not provided to CIM hardware module 601. In some embodiments, control logic 660 may perform this function by providing zeroes to CIM hardware module 601 in place of the negative elements. CIM hardware module 601 performs the VMM for the positive elements of the input vector. For example, logic gates 620 multiply each bit of each positive element with the corresponding bit of the weight stored in storage cell 610 at 502. In some embodiments, this may be accomplished by inverting the bit stored in each storage cell 610 and inverting the input bit and performing a NOR. At 504, these products are appropriately added using adder tree(s)) 630 and stored accumulated in accumulator(s) 640. Thus, a first output is determined. In addition, this first output is stored in additional storage 642. In some embodiments, negative weights stored in array 612 are accounted for in pre-existing circuitry of adder tree(s) 630 and/or accumulator(s) 640.

Similarly, control logic 660 provides the negative elements of the input vector stored in input buffer 650 to array 612 of CIM hardware module 601. The positive elements of the input vector stored in input buffer 650 are not provided to CIM hardware module 601. In some embodiments, control logic 660 may perform this function by providing zeroes to CIM hardware module 601 in place of the positive elements. CIM hardware module 601 performs the VMM for the negative elements of the input vector. For example, logic gates 620 multiply each bit of each negative element with the corresponding bit of the weight stored in storage cell 610 at 506. In some embodiments, this may be accomplished by inverting the bit stored in each storage cell 610 and inverting the input bit and performing a NOR. At 508, these products are appropriately added using adder tree(s)) 630 and stored accumulated in accumulator(s) 640. Thus, a second output is determined. In some embodiments, negative weights stored in array 612 are accounted for in pre-existing circuitry of adder tree(s) 630 and/or accumulator(s) 640. Subtraction unit 644 subtracts the second output from the first output. Thus, the VMM has been performed. Accumulator(s) 640 may then provide the resultant of the VMM to the output buffer.

In some embodiments, control logic 660 (or other logic of compute engine 600) may determine whether the elements of the input vector are all positive or all negative. In such embodiments, control logic 660, or other logic of compute engine 600, compute engine 600 performs only one set of VMMs. In such embodiments, compute engine 600 only implements 502 and 504 or 506 and 508 for all input vector elements being positive or all input vector elements being negative.

Compute engine 600 thus performs a VMM for input vectors having elements with positive and/or negative values. Further, the hardware in CIM hardware module 601 may not be significantly changed in order to accommodate input vectors capable of having negative elements. Instead, the positive and negative elements are separately treated using existing adder trees 630 and accumulators 640. Additional storage 642 and subtraction unit 644 may be added. Control logic 660 may determine the sign of each element of the input vector and provide the appropriate elements to array 612. Compute engine 600 may increase the time taken to perform the VMM. In some embodiments this increase in latency only occurs where both positive and negative input vector elements are present. Significant changes to circuitry in CIM hardware module 601 may be avoided. Further, compute engine 600 may reduce the peak power used in performing the VMM. When used in connection with eight transistor storage cells 410, lower power programming of storage cells 610 may also be achieved. Consequently, compute engine 600 may have improved flexibility for input vectors, a relatively small footprint, and lower power consumption. Thus, compute engine 600 may have particular utility for edge devices.

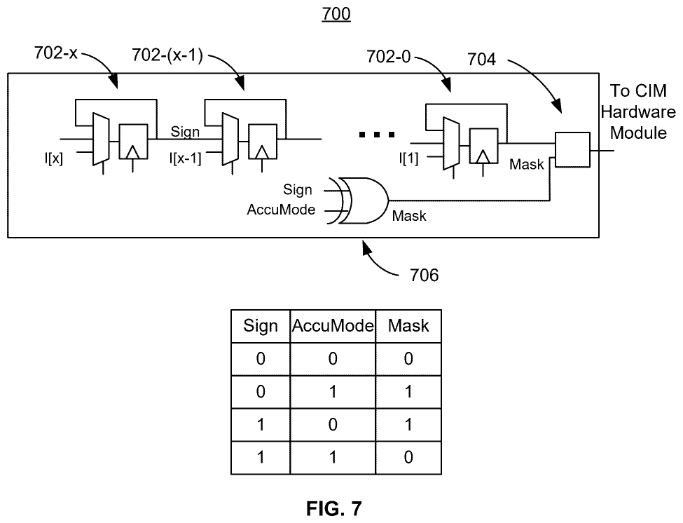

FIG. 7 depicts an embodiment of a portion of a compute engine usable in an accelerator for a learning network and which selectively provides positive and negative elements to a CIM hardware module. More specifically, FIG. 7 depicts control logic 700 that masks elements of input vectors. Control logic 700 that may be used as control logic 660 for input buffer 650 of compute engine 600. Control logic 700 be used for a particular row of an array of storage elements, such as a row of array 612. Also shown is a truth table for control signals used by control logic 700. In particular, the sign bit for the element of the input vector, the accumulation mode (AccuMode) control signal, and the mask bit are indicated in the truth table. The accumulation mode indicates whether positive elements of the input vector are undergoing a VMM. The mask bit indicates whether the bit for the element of the vector is masked (i.e. not contributing to the VMM).

Control logic 700 can be viewed as masking bits for input vector elements that are not to undergo a VMM. Thus, when positive input vector elements are undergoing VMMs, control logic 700 masks bits for negative input vector elements. When negative input vector elements are undergoing VMMs, control logic 700 mask bits for positive input vector elements. In some embodiments, Control logic 700 may be configured to forward to the CIM hardware module a 0 for masked bits and the value of the bit for unmasked bits. In some embodiments, control logic 700 may be configured to forward to the CIM hardware module the bits such that the multiplier (e.g. logic gates 620) outputs a 0 for masked bits and outputs the correct value for unmasked bits.

In the embodiment shown in FIG. 7, control logic 700 includes logic elements 702-1 through 702-x (collectively or generically element(s) 702), logic gate(s) 704, and mask logic 706. Control logic 700 includes an element 702 for each bit to be provided from the element of the input vector. The elements of an input vector are indicated by I[j]. In the embodiment shown, there are x bits to be provided (i.e. j is 1 through x and the input bits are I[1] through I[x]. For example, for vector elements that are eight bits long, x is 8 and j ranges from 1 through 8 (i.e. the bits input to control logic range from I[1] through I[8]). Logic elements 702 thus serialize the bits of the input vector element. Logic gates 704 provide the appropriate values to the CIM hardware module based on the mask signal (Mask) and the values of the bits of the input vector element.

Mask logic 706 includes a XOR gate in the embodiment shown. Mask logic 706 outputs a signal that determines whether the input vector element is masked. This signal is based on the sign of the input vector element and the accumulation mode control signal. For the embodiment indicated by the truth table, a sign bit of 0 indicates a positive number, while a sign bit of 1 indicates a negative number. For an accumulation mode signal AccuMode=0, positive input vector elements are undergoing a VMM. For an accumulation mode signal AccuMode=1, negative input vector elements are undergoing a VMM. For the sign bit of 0 and an accumulation mode control signal of 0, positive vector elements are to undergo a VMM and mask logic 706 provides a mask signal of 0. Thus, positive vector elements are not masked. For the sign bit of 0 and an accumulation mode control signal of 1, negative input vector elements are to undergo a VMM and mask logic 706 provides a mask signal of 1. Thus, positive vector elements are masked. For the sign bit of 1 and an accumulation mode control signal of 0, positive vector elements are to undergo a VMM and mask logic 706 provides a mask signal of 1. Thus, negative vector elements are masked. For the sign bit of 1 and an accumulation mode control signal of 1, negative input vector elements undergo a VMM and mask logic 706 provides a mask signal of 0. Thus, negative vector elements are not masked.

In operation, the bits I[j] of an input vector are provided to logic elements 702. With each time interval (e.g. clock cycle), the bits are forwarded to the right (closer to the output to the CIM hardware module). Thus, control logic 700 serializes the bits of the input vector element using logic elements 702. Logic gate(s) 704 serially receives bits of the input vector element and the mask signal indicated by the truth table. Logic gate(s) 704 may output the value of a bit for a mask signal of 0, and output a 0 for a mask signal of 1. In some embodiments, logic gate(s) 704 output a value the results in the appropriate output for multiplication by logic gate(s) 420 or 620 for a mask signal of 0 and output a value that results in a 0 for multiplication by logic gate(s) 420 or 620 for a mask signal of 1. For example, if logic gate(s) 420 or 620 expect the inverse of the bit for the input vector element, then logic gate(s) 704 may output a 1 for a mask signal of 1 and the inverse of the bit value for a mask signal of 0. In the embodiment shown, logic gate(s) 704 may be an OR gate. In other embodiments, logic gate(s) 704 may be different. For a mask signal of 0, an OR gate 704 outputs the bit vector element. Thus, if the bit is a 0 and the mask signal is 0, logic gate 704 also outputs a 0. If the bit is a 1 and the mask signal is 0, logic gate 704 outputs a 1. For a mask signal of 1, logic gate 704 provides a 1 for both the bit signal being 0 or 1. In such embodiments, logic gates 420 or 620 that perform the multiplication may be an XOR gate that utilizes the inverse of the input bits.

Control logic 700 thus provides the appropriate input to the CIM hardware module with which control logic 700 is used. Thus, only positive input vector elements or only negative input vector elements are provided to the corresponding CIM hardware modules. As a result, the compute engine in which control logic 700 is used may separately perform VMMs for positive input vector elements and negative input vector elements. The compute engine using control logic 700 may have improved flexibility for input vectors, a relatively small footprint, and lower power consumption.

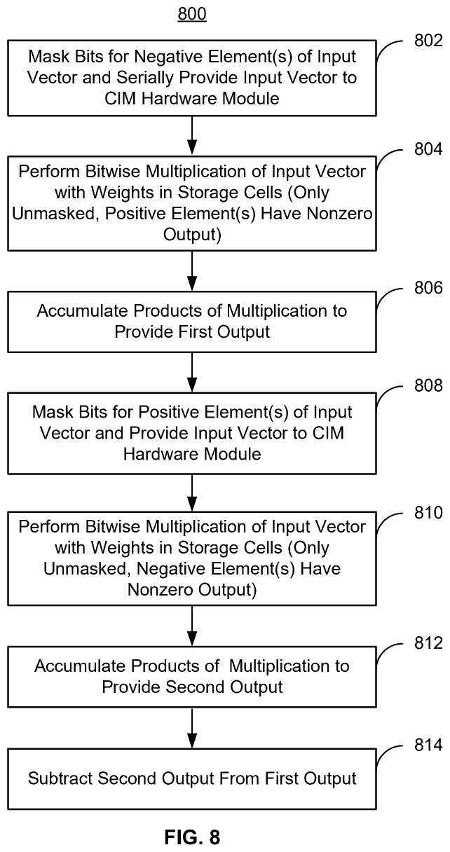

FIG. 8 is a flow chart depicting an embodiment of method 800 for using a compute engine for performing operations using positive and negative values. More specifically, method 800 may be used for performing VMMs for input vectors having elements which may be positive or negative. Method 800 is described in the context of compute engine 600 and control logic 660 or 700. For example, a matrix of weights may be stored in storage cells (e.g. storage cells 610) in array 612 of CIM module 601. Thus, method 800 is described in the context of a digital CIM module 601 and compute engine 600. However, method 800 is usable with other compute engines and CIM hardware modules, such as compute engine(s) 100 and/or 200, compute tile 150, CIM hardware module 230, other compute engine(s), other CIM hardware module(s) and/or other compute tile(s). Although particular processes are shown in an order, the processes may be performed in another order, including in parallel. Further, processes may have substeps.

Bits for negative elements are masked and the input vector elements are provided to a CIM hardware module, at 802. Because the bits for the negative elements of the input vector are masked, the multiplication for these elements is zero and does not contribute to the VMM. Thus, 802 may be viewed as only providing positive elements of the input vector to the CIM hardware module.

The positive elements of the input vector are multiplied by the corresponding weights stored in storage cells, at 804. Because of the masking in 802, the negative elements multiplied at 804 do not contribute to the multiplication (i.e. are zero). In some embodiments, 804 includes performing a bit serial multiplication for each positive element of the input vector and each weight.

The products of the multiplication performed in 804 are accumulated, at 806. Stated differently, the products of 804 are added and stored. In some embodiments, 806 may be considered to be implemented by an adder tree and accumulator. Thus, at 806, the vector matrix multiplication of the positive elements of the input vector with corresponding elements of the weight matrix is stored as a first output.

Bits for positive elements are masked and the input vector elements are provided to a CIM hardware module, at 808. Because the bits for the positive elements of the input vector are masked, the multiplication for these elements is zero and does not contribute to the VMM. Thus, 804 may be viewed as only providing positive elements of the input vector to the CIM hardware module.

Negative elements of the input vector are multiplied by the corresponding weights stored in storage cells, at 810. Because of the masking in 808, the positive elements multiplied at 810 do not contribute to the multiplication (i.e. are zero). In some embodiments, 810 includes performing a bit serial multiplication for each positive element of the input vector and each weight.

The products of the multiplication performed in 810 are accumulated, at 812. Thus, the products of 810 are added and stored at 812. In some embodiments, 812 may be considered to be implemented by an adder tree and accumulator. Thus, at 812, the vector matrix multiplication of the negative elements of the input vector with corresponding elements of the weight matrix is stored as a second output. Because the positive and negative elements of the input vector are separated into different multiplication processes at 804 and 806 (positive) and 810 and 812 (negative), the same hardware may be used to perform 804, 806, 810, and 812 without separately accounting for the signs of the elements of the input vector. At 814, the second output (negative input vector elements) is subtracted from the first output (positive input vector elements). Thus, the resultant of the VMM has been determined.

For example, at 802, control logic 660 or 700 may mask bits for negative elements. This may include determination of the mask signal by XOR gate 706, serialization of the input vector element bits using elements 702, and applying the mask by logic gate(s) 704. Also at 802 the (unmasked and masked) input vector elements are provided to CIM hardware module 601. For example, logic gate(s) 704 may provide the input vector element(s) to each row of array 612. Thus, the positive elements of the input vector are provided from input buffer 650 to CIM hardware module 601. At 804, CIM hardware module 601 performs the VMM for the positive elements of the input vector. For example, logic gates 620 multiply each bit of each positive element with the corresponding bit of the weight stored in storage cell 610. Although the masked bits may undergo multiplication, the product is zero. Thus, negative elements of the input vector do not contribute to the VMM. At 806, these products are appropriately added via adder tree(s) 630 and accumulator(s) 640. This first output is stored in additional storage 642 of accumulator(s) 640. In some embodiments, 806 may include accounting for negative weights in the adder tree(s) and/or accumulator(s). At 806, the first output of the VMM for the positive elements of the input vector may be stored separately, for example in a cache.

Similarly, control logic 660 or 700 may mask bits for positive elements at 808. This may include determination of the mask signal by XOR gate 706, serialization of the input vector element bits using elements 702, and applying the mask by logic gate(s) 704. Also at 808 the (unmasked and masked) input vector elements are provided to CIM hardware module 601. For example, logic gate(s) 704 may provide the input vector element(s) to each row of array 612. Thus, the negative elements of the input vector are provided from input buffer 650 to CIM hardware module 601. At 810, CIM hardware module 601 performs the VMM for the negative elements of the input vector. For example, logic gates 620 multiply each bit of each negative element with the corresponding bit of the weight stored in storage cell 610 at 810. Although the masked bits may undergo multiplication, the product is zero. Thus, positive elements of the input vector do not contribute to the VMM of 810. At 812, these products are appropriately added via adder tree(s) 630 and accumulator(s) 640. In some embodiments, 812 may include accounting for negative weights in the adder tree(s) and/or accumulator(s). Thus, the second output of the VMM for negative elements of the input vector has been determined. At 814, the second output is subtracted from the first output using subtraction unit 644. Thus, the VMM has been performed.

Using method 800, a VMM may be performed for input vectors having elements with positive and/or negative values. Further, the hardware in CIM hardware module 601 may not be significantly changed in order to accommodate input vectors capable of having negative elements. Instead, the positive and negative elements are separately treated. Additional storage 642 for storing the first output during determination of the second output and subtraction unit 644 may simply be added. Although method 800 is described in the context of performing VMMs for the positive elements of the input vector first, nothing prevents performing VMMs for the negative elements of the input vector from being performed first. Although method 800 may increase the time taken to perform the VMM, significant additional circuitry may be avoided. Further, method 800 may reduce the peak power used in performing the VMM.

Although the foregoing embodiments have been described in some detail for purposes of clarity of understanding, the invention is not limited to the details provided. There are many alternative ways of implementing the invention. The disclosed embodiments are illustrative and not restrictive.

1. A compute engine, comprising:
a memory including a plurality of storage cells; and
compute logic coupled with the memory, the compute logic being configured to perform a vector matrix multiplication (VMM) of an input vector with data stored in each of the plurality of storage cells, the input vector including at least one positive element and at least one negative element;
wherein the compute logic is configured to perform the VMM by multiplying the at least one positive element with data stored in each storage cell of a first portion of the plurality of storage cells corresponding to the at least one positive element to provide at least one first product, accumulate as a first output the at least one first product for each storage cell of the first portion of the plurality of storage cells, multiplying the at least one negative element with data stored in each storage cell of a second portion of the plurality of storage cells corresponding to the at least one negative element to provide at least one second product, accumulate as a second output the at least one second product for each storage cell of the second portion of the plurality of storage cells, and subtract the second output from the first output to provide a VMM output.

2. The compute engine of claim 1, wherein the memory and at least a portion of the compute logic are part of a compute-in-memory (CIM) hardware module and wherein the compute engine is configured to present only the at least one positive element to the CIM hardware module to provide the at least one first product and to present only the at least one negative element to the CIM hardware module to provide the at least one second product.

3. The compute engine of claim 1, wherein the memory and at least a portion of the compute logic are part of a compute-in-memory (CIM) hardware module, the compute engine further comprising:
an input buffer coupled with the CIM hardware module, the input buffer being configured to separately provide the at least one positive element to the CIM hardware module and provide the at least one negative element to the CIM hardware module.

4. The compute engine of claim 3, wherein the input buffer is configured to present only the at least one positive element to the CIM hardware module to provide the at least one first product and to present only the at least one negative element to the CIM hardware module to provide the at least one second product.

5. The compute engine of claim 4, wherein the input buffer includes control logic configured to mask the at least one negative element for the at least one first product and to mask the at least one positive element for the at least one second product.

6. The compute engine of claim 5, wherein the input buffer is further configured to serialize the at least one negative element and the at least one positive element.

7. The compute engine of claim 1, wherein the compute logic further includes at least one logic gate coupled to each of the plurality of storage cells and configured to perform a multiplication of a portion of the input vector and the data in each of the plurality of storage cells.

8. The compute engine of claim 7, wherein each of the plurality of storage cells is programmable by a voltage not exceeding 0.6 Volts.

9. A compute tile, comprising:
at least one general-purpose (GP) processor; and
a plurality of compute engines coupled with the at least one GP processor, each compute engine of the plurality of compute engines including a compute-in-memory (CIM) hardware module including memory and compute logic coupled with the memory, the memory including a plurality of storage cells, the compute logic being configured to perform a vector matrix multiplication (VMM) of an input vector with data stored in each of the plurality of storage cells, the input vector including at least one positive element and at least one negative element;
wherein each of the plurality of compute engines is configured to perform the VMM by:
multiplying, using the compute logic, the at least one positive element with data stored in each storage cell of a first portion of the plurality of storage cells corresponding to the at least one positive element to provide at least one first product;
accumulating, using the compute logic, as a first output the at least one first product for each storage cell of the first portion of the plurality of storage cells;
multiplying, using the compute logic, the at least one negative element with data stored in each storage cell of a second portion of the plurality of storage cells corresponding to the at least one negative element to provide at least one second product;
accumulating, using the compute logic, as a second output the at least one second product for each storage cell of the second portion of the plurality of storage cells; and
subtracting, using the compute logic, the second output from the first output to provide a VMM output.

10. The compute tile of claim 9, wherein the compute engine is configured to present only the at least one positive element to the CIM hardware module to provide the first product and to present only the at least one negative element to the CIM hardware module to provide the second product.

11. The compute tile of claim 9, wherein each of the plurality of compute engines further includes:
an input buffer coupled with the CIM hardware module, the input buffer being configured to separately provide the at least one positive element to the CIM hardware module and provide the at least one negative element to the CIM hardware module.

12. The compute tile of claim 11, wherein the input buffer is configured to present only the at least one positive element to the CIM hardware module to provide the at least one first product and to present only the at least one negative element to the CIM hardware module to provide the at least one second product.

13. The compute tile of claim 11, wherein the input buffer includes control logic configured to mask the at least one negative element for the at least one first product and to mask the at least one positive element for the at least one second product.

14. The compute tile of claim 13, wherein the input buffer is further configured to serialize the at least one negative element and the at least one positive element.

15. The compute tile of claim 9, wherein the compute logic further includes at least one logic gate coupled to each of the plurality of storage cells and configured to perform a multiplication of a portion of the input vector and the data in each of the plurality of storage cells.

16. The compute tile of claim 9, wherein each of the plurality of storage cells is programmable by a voltage not exceeding 0.6 Volts.

17. A method, comprising:
performing, by a compute engine, a vector-matrix multiplication (VMM) of an input vector and a matrix, the matrix including data stored in each of a plurality of storage cells of a memory of the compute engine, the memory being coupled with compute logic, the input vector including at least one positive element and at least one negative element, the performing the VMM further including
multiplying the at least one positive element with data stored in each storage cell of a first portion of the plurality of storage cells corresponding to the at least one positive element to provide at least one first product;
accumulating as a first output the at least one first product for each storage cell of the first portion of the plurality of storage cells;
multiplying the at least one negative element with data stored in each storage cell of a second portion of the plurality of storage cells corresponding to the at least one negative element to provide at least one second product;
accumulating as a second output the at least one second product for each storage cell of the second portion of the plurality of storage cells; and
subtracting the second output from the first output to provide a VMM output.

18. The method of claim 17, wherein the multiplying the at least one positive element with the data further includes:
presenting only the at least one positive element to a compute-in-memory (CIM) hardware module including the memory and the compute logic to provide the at least one first product; and wherein the multiplying the at least one negative element with the data further includes:
presenting only the at least one negative element to the CIM hardware module to provide the at least one second product.

19. The method of claim 18, wherein the presenting only the at least one positive element further includes:
masking the at least one negative element for the at least one first product; and wherein the presenting only the at least one negative element further includes
masking the at least one positive element for the at least one second product.

20. The method of claim 18, wherein the presenting only the at least one positive element further includes:
serializing the at least one positive element; and wherein the presenting only the at least one negative element further includes
serializing the at least one negative element.
